(19) United States
(12) Patent Application Publication
(10) Pub. No.: US 2003/0215087 A1
(43) Pub. Date: Nov. 20, 2003

(54) Mobile phone hands-free kit with a sound-pickup device Mobile phone hands-free kit with a sound-pickup device

(76) Inventor: Huo-Lu Tsai, Taichung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/158,021

(22) Filed: May 29, 2002

(30) Foreign Application Priority Data
May 16, 2002 (TW) 91207009

(51) Int. Cl. H04M 1/00; H04M 9/00

(52) U.S. Cl. 379/428.01

(57) ABSTRACT

A mobile phone hands-free kit includes a housing body, a speaker unit, a sound-pickup device, and a mounting device for mounting the sound-pickup device movably on the housing body such that the sound-pickup device is movable relative to the housing body in a linear direction so as to register a sound receiving cup of the sound-pickup device with a sound outlet of a mobile phone on the housing body such that an incoming call output from the mobile phone can be transmitted to the speaker unit for subsequent reproduction.

### BACKGROUND OF THE INVENTION

1. Field of the Invention

The invention relates to a mobile phone hands-free kit, more particularly to a mobile phone hands-free kit with a sound-pickup device.

2. Description of the Related Art

Referring to FIG. 1, a conventional mobile phone hands-free kit is shown to comprise a speaker module 1 including a cigarette lighter adapter plug 101 and a speaker unit 102, a sound-pickup device 2 including a mounting sleeve 201, a threaded sleeve 202, a support arm 203 and a sound receiving cup 204, and a phone seat 3 that retains a mobile phone 4 thereon. The cigarette lighter adapter plug 101 is adapted to be plugged into the cigarette lighter socket of an automobile for supplying power to the speaker unit 102. The mounting sleeve 201 has one end secured to the phone seat 3. The threaded sleeve 202 has one end threadedly coupled to the other end of mounting sleeve 201. The support arm 203 has one end coupled to the other end of the threaded sleeve 202 such that the support arm 203 is pivotable about the axis of the threaded sleeve 202. The sound receiving cup 204 is mounted on the other end of the support arm 203. When the mobile phone 4 is retained on the phone seat 3, the user can first adjust the threaded sleeve 202 such that the support arm 203 together with the sound receiving cup 204 is moved toward the front side of the mobile phone 4. Then, the sound receiving cup 204 is adjusted to be disposed adjacent to the sound outlet 401 of the mobile phone 4 by pivoting the support arm 203 about the axis of the threaded sleeve 202. As such, an incoming call output from the sound outlet 401 of the mobile phone 4 can be received by the sound receiving cup 204 and can be transmitted to the speaker unit 102 for subsequent reproduction. On the other hand, an outgoing call output is picked up directly by a microphone (not shown) of the mobile phone 4.

The following is a drawback of the aforesaid conventional hands-free kit: The sound outlet 401 of the mobile phone 4 is generally disposed at a vertical center line of the front side of the mobile phone 4. However, the sound outlets 401 of different mobile phones 4 may be located at different heights relative to the bottom sides of the mobile phones 4 due to the different dimensions of the mobile phones 4. It is noted that the track yielded by pivoting the support arm 203 about the axis of the threaded sleeve 202 for moving the sound receiving cup 204 is circular. Therefore, the sound receiving cup 204 is only able to fully cover the sound outlets 401 of mobile phones 4 within a limited range of heights. In other words, when applied to mobile phones 4 having heights that do not fall within the specified range, the sound pickup effect will be poor due to the fact that the sound outlet 401 is not fully covered by the sound receiving cup 204.

### SUMMARY OF THE INVENTION

Therefore, the main object of the present invention is to provide a mobile phone hands-free kit that can overcome the aforesaid drawback associated with the prior art.

Accordingly, the mobile phone hands-free kit of this invention is adapted for use with a mobile phone having front and rear sides opposite to each other relative to a first axis, opposite lateral sides opposite to each other relative to a second axis transverse to the first axis, and top and bottom sides opposite to each other relative to a third axis transverse to the first and second axes. The front side of the mobile phone is formed with a sound outlet. The mobile phone hands-free kit comprises:

a housing body adapted to be mounted in a passenger room of an automobile;

a speaker unit mounted in the housing body; a retaining unit mounted on the housing body and adapted to retain the mobile phone removably on the housing body;

a sound-pickup device mounted on the housing body and coupled electrically to the speaker unit, the sound-pickup device having a sound receiving cup movable relative to the housing body from a first position, where the sound receiving cup is remote from the sound outlet of the mobile phone on the housing body, to a second position, where the sound receiving cup is disposed in close proximity to the sound outlet of the mobile phone on the housing body such that an incoming call output from the sound outlet of the mobile phone can be received by the sound-pickup device and can be transmitted by the sound-pickup device to the speaker unit for subsequent reproduction; and

a mounting device for mounting the sound-pickup device movably on the housing body such that the sound-pickup device is movable relative to the housing body in a linear direction parallel to the third axis so as to permit movement of the sound receiving cup parallel to the third axis in order to register the sound receiving cup with the sound outlet of the mobile phone on the housing body.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional mobile phone hands-free kit with a sound-pickup device;

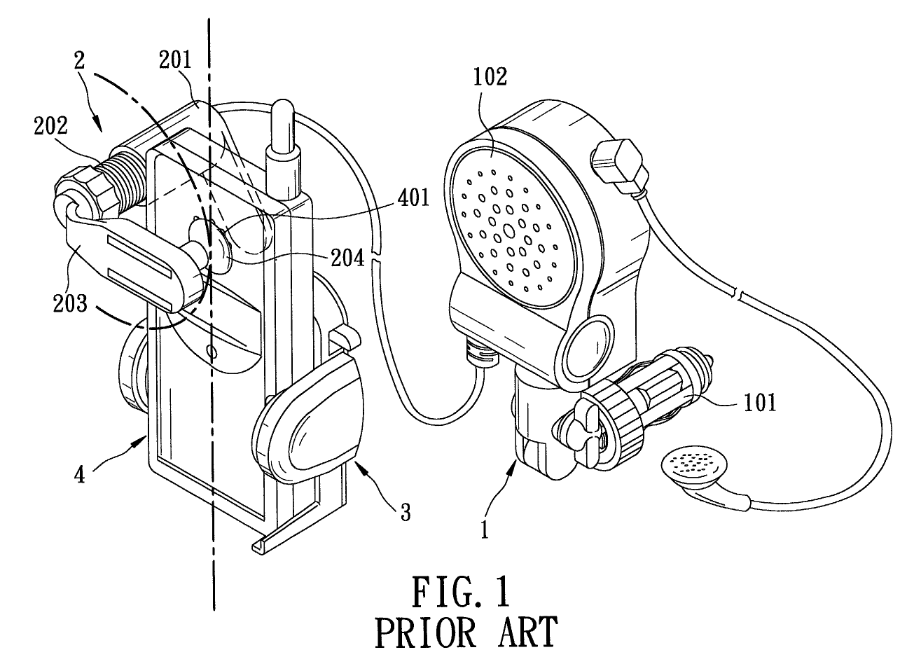

FIG. 2 is a partly exploded perspective view of a first preferred embodiment of a mobile phone hands-free kit according to the present invention;

FIG. 3 is an assembled perspective view of the first preferred embodiment of the present invention;

FIG. 4 is a schematic bottom view of the first preferred embodiment of the present invention for illustrating first and second positions of a sound receiving cup;

FIG. 5 is a schematic front view of the first preferred embodiment of the present invention;

FIG. 6 is a schematic side view of the first preferred embodiment of the present invention;

FIG. 7 is an assembled perspective view of the first preferred embodiment of the present invention in a state of use; and

FIG. 8 is a partly exploded schematic side view of a second preferred embodiment of a mobile phone hands-free kit according to the present invention;

### DETAILED DESCRIPTION OF THE PREFERRED EMBODIMENTS

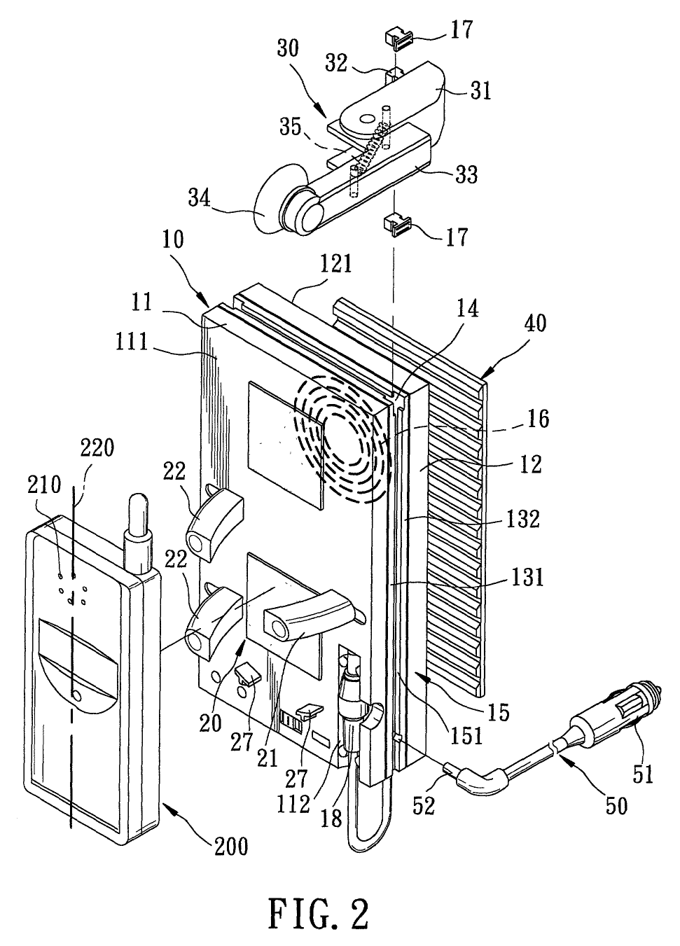

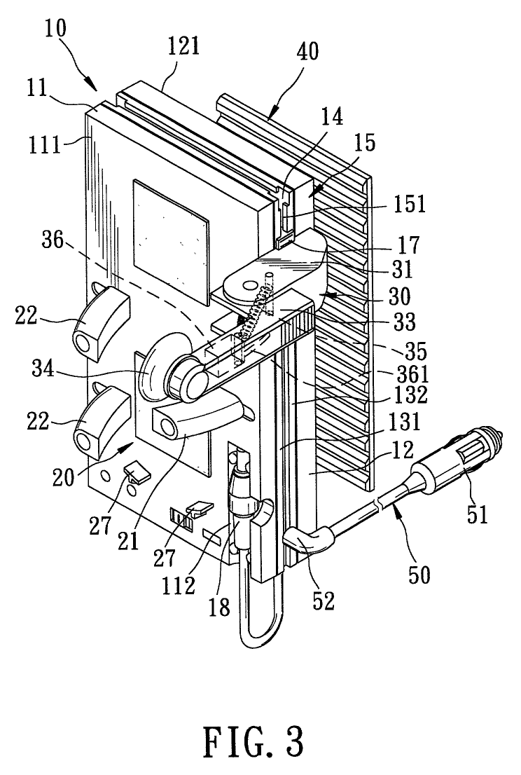

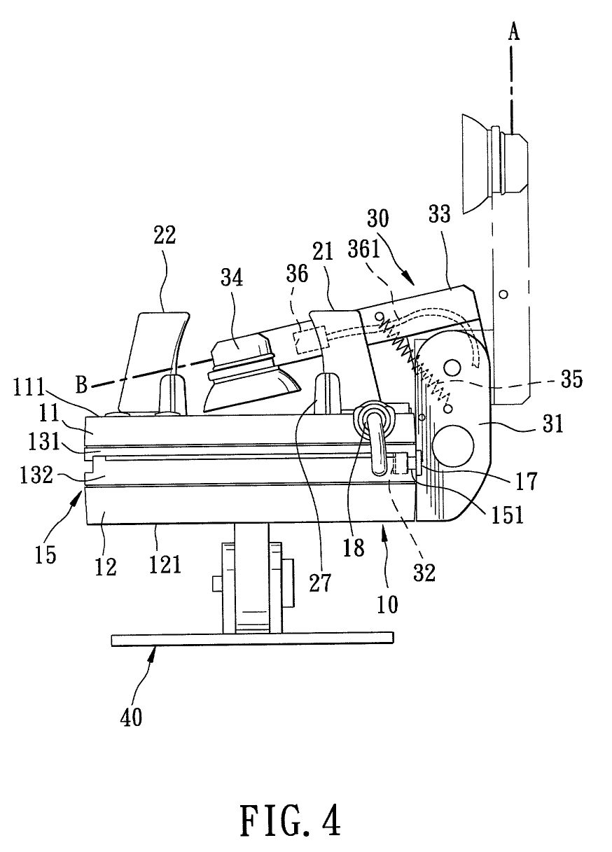

Referring to FIGS. 2, 3 and 4, the preferred embodiment of a mobile phone hands-free kit according to the present invention is shown to be adapted for use with a mobile phone 200 having front and rear sides opposite to each other relative to a first axis, opposite lateral sides opposite to each other relative to a second axis transverse to the first axis, and top and bottom sides opposite to each other relative to a third axis transverse to the first and second axes. The front side of the mobile phone 200 is formed with a sound outlet 201 that is disposed at a vertical center line 220 of the front side. The mobile phone hands-free kit comprises a housing body 10, a speaker unit 16, a retaining unit 20, a sound-pickup device 30, a mounting device, and a cigarette lighter adapter plug 50.

The housing body 10 is adapted to be mounted in a passenger room of an automobile, and includes a front housing part 11 formed with a front side 111 and having a rear open end, a front cover plate 131 mounted on the front housing part 11 to close the rear open end, a rear housing part 12 formed with a rear side 121 and having a front open end, and a rear cover plate 132 mounted on the rear housing part 12 to close the front open end. The housing body 10 has a lateral side 15 interconnecting the front and rear sides 111, 121. The front and rear cover plates 131, 132 are connected to each other and cooperate to form a clearance 14 between the front and rear housing parts 11, 12. The clearance 14 forms a slide groove 151 at the lateral side 15 of the housing body 10. The slide groove 151 serves as a slide rail.

The speaker unit 16 is mounted in the rear housing part 12 of the housing body 10. The rear side 121 of the housing body 10 is formed with sound holes for the speaker unit 16.

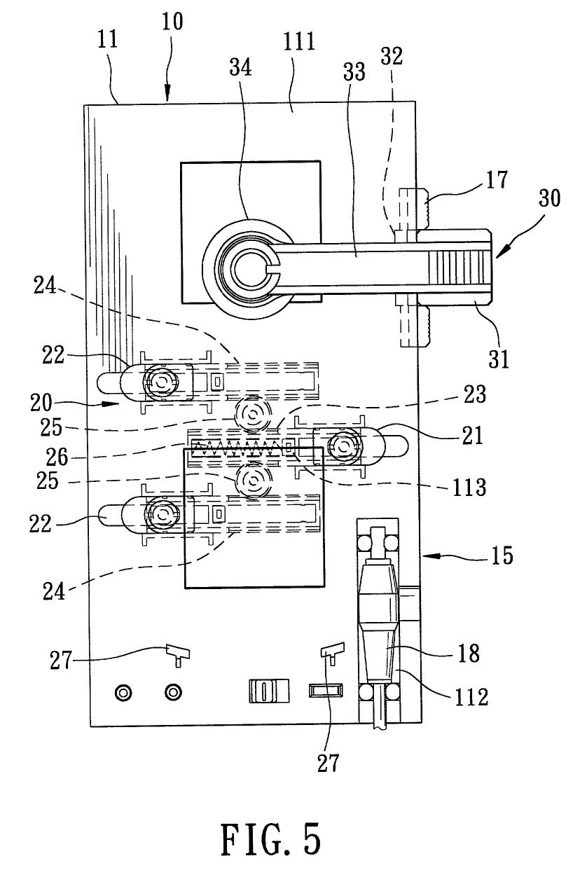

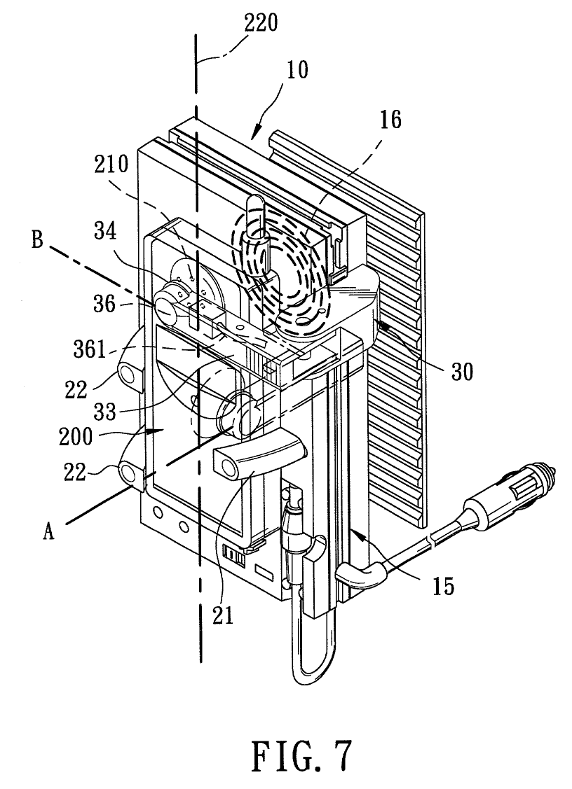

Referring further to FIGS. 5 and 7, the retaining unit 20 is shown to include a first retainer 21, two second retainers 22, an inner rack 23, two outer racks 24, two sprockets 25, a biasing member 26, and two support blocks 27. The first and second retainers 21, 22 are mounted on the front side 111 of the housing body 10, and are adapted to engage the lateral sides of the mobile phone 200 for retaining the mobile phone 200 on the housing body 10. The first and second retainers 21, 22 are movable relative to each other to permit removal of the mobile phone 200 from the housing body 10. The inner and outer racks 23, 24 extend parallel to the second axis, are disposed in the housing body 10, are spaced apart from each other relative to the third axis, and are coupled to the first and second retainers 21, 22, respectively. The sprockets 25 are mounted in the housing body 10, are disposed between the inner and outer racks 23, 24, and mesh with the inner and outer racks 23, 24. The biasing member 26 is a compression spring in this embodiment, and has one end abutting against one end of the inner rack 23 and the other end abutting against a mounting block 113 in the housing body 10. The biasing member 26 serves to bias the first retainer 21 toward the second retainers 22. The support blocks 27 project from the front side 111 of the housing body 10 for supporting the bottom side of the mobile phone 200 thereon. When the mobile phone 200 is to be disposed in a retaining space formed by the first and second retainers 21, 22 and the support blocks 27, the first and second retainers 21, 22 can be moved away from each other in directions parallel to the second axis. Thereafter, by virtue of the biasing member 26, the inner rack 23 will be pulled toward the center line 220 of the mobile phone 200, thereby moving the outer racks 24 toward the center line 220 of the mobile phone 200 via the meshing action of the sprockets 25, respectively. The first and second retainers 21, 22 engage the lateral sides of the mobile phone 200 at this time to retain the mobile phone 200 on the housing body 10.

The sound-pickup device 30 is mounted on the housing body 10 and is coupled electrically to the speaker unit 16. The sound-pickup device 30 includes a support arm 31, a pivot arm 33, a sound receiving cup 34, a pull spring 35 and a microphone 36. The support arm 31 has a first end mounted on the housing body 10 via the mounting device, and a second end opposite to the first end in a direction parallel to the first axis. The pivot arm 33 has a pivot end coupled pivotally to the second end of the support arm 31 about a pivot axis parallel to the third axis, and a support end opposite to the pivot end and having the sound receiving cup 34 mounted thereon. The pull spring 35 interconnects the support arm 31 and the pivot arm 33, and biases the pivot arm 33 to pivot relative to the support arm 31. The microphone 36 is mounted in the pivot arm 33 and is coupled electrically to the speaker unit 16 via a signal transmission line 361 that extends into the clearance 14 of the housing body 10. The pivot arm 33 is pivotable relative to the support arm 31 about the pivot axis to move the sound receiving cup 34 away from the front side 111 of the housing body 10 so as to dispose the sound receiving cup 34 at a first position (A), where the sound receiving cup 34 is remote from the sound outlet 210 of the mobile phone 200 on the housing body 10, and toward the front side 111 of the housing body 10 so as to dispose the sound receiving cup 34 at a second position (B) , where the sound receiving cup 34 is disposed in close proximity to the sound outlet 210 of the mobile phone 200 on the housing body 10. When the sound receiving cup 34 is moved relative to the housing body 10 from the first position (A) to the second position (B), an incoming call output from the sound outlet 210 of the mobile phone 200 can be received by the sound-pickup device 30 and can be transmitted by the sound-pickup device 30 to the speaker unit 16 for subsequent reproduction in a known manner.

The mounting device is used for mounting the sound-pickup device 30 movably on the housing body 10 such that the sound-pickup device 30 is movable relative to the housing body 10 in a linear direction parallel to the third axis so as to permit movement of the sound receiving cup 34 parallel to the third axis in order to register the sound receiving cup 34 with the sound outlet 210 of the mobile phone 200 on the housing body 10. The mounting device 40 includes the slide rail, i.e. the slide groove 151, in the housing body 10, and a slide member 32 provided on support arm 31 and slidably engaging the slide rail to permit movement of the sound-pickup device 30 in the linear direction relative to the housing body 10. In this embodiment, the mounting device further includes a pair of positioning blocks 17 mounted on the slide member 32. The positioning blocks 17 extend into the slide groove 151 for friction engagement with the housing body 10 to resist unforced movement of the sound pick-up device 30 in the linear direction relative to the housing body 10.

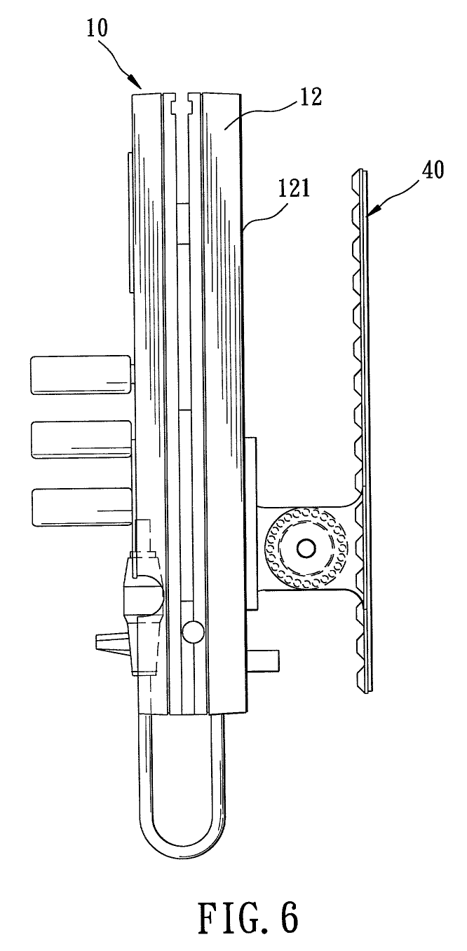

Referring to FIG. 6, preferably, a mounting plate 40 is coupled pivotally to the rear side 121 of the housing body 10 and is adapted to mount the housing body 10 in the passenger room of the automobile such that the housing body 10 can be retained at different inclinations.

The cigarette lighter adapter plug 50 includes a first plug end 51 and a second plug end 52. The first plug end 51 is adapted to be plugged into a cigarette lighter socket of the automobile. The second plug end 52 is adapted to be plugged into the housing body 10 so that power can be supplied to the speaker unit 16.

Preferably, the hands-free kit further includes a battery charging plug 18 connected electrically to the speaker unit 16 to permit charging of the mobile phone 200 in a known manner. The front side 111 of the housing body 10 is formed with a recess 112 for removably retaining the battery charging plug 18 therein.

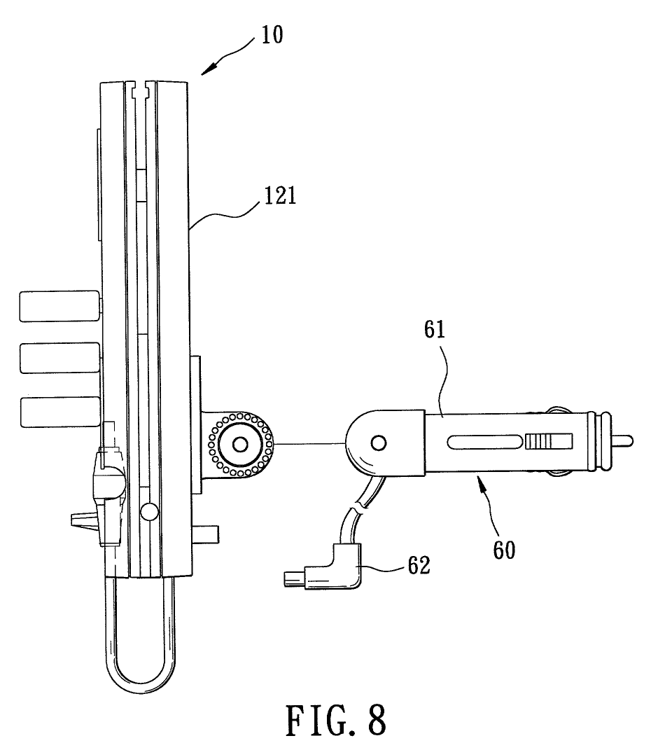

Referring to FIG. 8, in a second preferred embodiment of the present invention, the cigarette lighter adapter plug 60 is shown to include a first plug end 61 and a second plug end 62. The plug 60 is coupled pivotably to the rear side 121 of the housing body 10. Thus, when the first plug end 61 is plugged into the cigarette lighter socket of an automobile, the mobile phone hands-free kit is at the same time mounted to the automobile.

The following are some of the advantages of the hands-free kit of this invention:

1. The linearly movable sound-pickup device 30 in this invention can be adjusted to align the sound receiving cup 34 with the sound outlet 201 of different mobile phones 200 without the drawback of the circularly movable sound-pickup device of the prior art.

2. The sound-pickup device 30 in this invention can be selectively mounted on either lateral side 15 of the housing body 10, thereby resulting in greater flexibility when the mobile phone hands-free kit of this invention is in use.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

LIST OF PARTNERS OF CHRISTENSEN O' CONNOR JOHNSON & KINDNESS^{PLLC}

Bruce E. O' Connor, Reg. No. 24,849;

Lee E. Johnson, Reg. No. 22,946;

Gary S. Kindness, Reg. No. 22,178;

James W. Anable, Reg. No. 26,827;

James R. Uhlir, Reg. No. 25,096;

Jerald E. Nagae, Reg. No. 29,418;

Dennis K. Shelton, Reg. No. 26,997;

Jeffrey M. Sakoi, Reg. No.

32,059;

Ward Brown, Reg. No. 28,400;

Robert J. Carlson, Reg. No. 35,472;

Rodney C. Tullett, Reg. No. 34,034;

Daiva K. Tautvydas, Reg. No. 36,077;

Mary L. Culic, Reg. No. 40,574;

Julie C. VanDerZanden, Reg. No. 38,105;

George E. Renzoni, Reg. No. 37,919;

Philip P. Mann, Reg. 30,960;

George S. Farber, Reg. No. 41,497;

Kevan L. Morgan, Reg. No. 42,015; and

John D. Denkenberger, Reg. No. 44,060.

I claim:

1. A mobile phone hands-free kit adapted for use with a mobile phone having front and rear sides opposite to each other relative to a first axis, opposite lateral sides opposite to each other relative to a second axis transverse to the first axis, and top and bottom sides opposite to each other relative to a third axis transverse to the first and second axes, the front side of the mobile phone being formed with a sound outlet, said mobile phone hands-free kit comprising:
a housing body adapted to be mounted in a passenger room of an automobile;
a speaker unit mounted in said housing body;
a retaining unit mounted on said housing body and adapted to retain the mobile phone removably on said housing body;
a sound-pickup device mounted on said housing body and coupled electrically to said speaker unit, said sound-pickup device having a sound receiving cup movable relative to said housing body from a first position, where said sound receiving cup is remote from the sound outlet of the mobile phone on said housing body, to a second position, where said sound receiving cup is disposed in close proximity to the sound outlet of the mobile phone on said housing body such that an incoming call output from the sound outlet of the mobile phone can be received by said sound-pickup device and can be transmitted by said sound pickup device to said speaker unit for subsequent reproduction; and
a mounting device for mounting said sound-pickup device movably on said housing body such that said sound-pickup device is movable relative to said housing body in a linear direction parallel to the third axis so as to permit movement of said sound receiving cup parallel to the third axis in order to register said sound receiving cup with the sound outlet of the mobile phone on said housing body.

2. The mobile phone hands-free kit as claimed in claim 1, wherein said housing body has a front side, a rear side opposite to said front side, and a lateral side interconnecting said front and rear sides,
said mounting device including a slide rail formed at said lateral side of said housing body and extending in the linear direction, and a slide member provided on said sound-pickup device and slidably engaging said slide rail to permit movement of said sound-pickup device in the linear direction relative to said housing body.

3. The mobile phone hands-free kit as claimed in claim 2, wherein said housing body includes a front housing part formed with said front side and having a rear open end, a front cover plate mounted on said front housing part to close said rear open end, a rear housing part formed with said rear side and having a front open end, and a rear cover plate mounted on said rear housing part to close said front open end, said front and rear cover plates being connected to each other and cooperating to form a clearance between said front and rear housing parts, said clearance forming a slide groove at said lateral side of said housing body, said slide groove serving as said slide rail, said slide member on said sound-pickup device being in sliding engagement with said slide groove.

4. The mobile phone hands-free kit as claimed in claim 3, further comprising a positioning block mounted on said slide member and extending into said slide groove for friction engagement with said housing body to resist unforced movement of said sound pickup device in the linear direction relative to said housing body.

5. The mobile phone hands-free kit as claimed in claim 2, further comprising a positioning block mounted on said slide member and in friction engagement with said slide rail to resist unforced movement of said sound pickup device in the linear direction relative to said housing body.

6. The mobile phone hands-free kit as claimed in claim 1, wherein said housing body has a front side, and said sound-pickup device further includes:
a support arm having a first end mounted on said housing body via said mounting device, and a second end opposite to said first end in a direction parallel to the first axis; and
a pivot arm having a pivot end coupled pivotally to said second end of said support arm about a pivot axis parallel to the third axis, and a support end opposite to said pivot end and having said sound receiving cup mounted thereon;
said pivot arm being pivotable relative to said support arm about said pivot axis to move said sound receiving cup away from said front side of said housing body so as to dispose said sound receiving cup at the first position, and toward said front side of said housing body so as to dispose said sound receiving cup at the second position.

7. The mobile phone hands-free kit as claimed in claim 6, wherein said sound-pickup device further includes a pull spring interconnecting said support arm and said pivot arm and biasing said pivot arm to pivot relative to said support arm so as to dispose said sound receiving cup at the second position.

8. The mobile phone hands-free kit as claimed in claim 6, wherein said sound-pickup device further includes a microphone disposed in said pivot arm and coupled electrically to said speaker unit.

9. The mobile phone hands-free kit as claimed in claim 1, wherein said housing body has a front side, and said retaining unit includes first and second retainers mounted on said front side of said housing body and adapted to engage the lateral sides of the mobile phone for retaining the mobile phone on said housing body, said first and second retainers being movable relative to each other to permit removal of the mobile phone from said housing body.

10. The mobile phone hands-free kit as claimed in claim 9, wherein said first retainer is mounted movably on said front side of said housing body and is movable relative to said second retainer in a direction parallel to the second axis.

11. The mobile phone hands-free kit as claimed in claim 10, wherein said retaining unit further includes a biasing member for biasing said first retainer toward said second retainer.

12. The mobile phone hands-free kit as claimed in claim 9, wherein said first and second retainers are mounted movably on said front side of said housing body and are movable relative to said housing body in directions parallel to the second axis from a releasing position, where said first and second retainers move away from each other to permit removal of the mobile phone from said housing body, to a retaining position, where said first and second retainers move toward each other to engage the lateral sides of the mobile phone, respectively.

13. The mobile phone hands-free kit as claimed in claim 9, wherein said retaining unit further includes:
inner and outer racks extending parallel to the second axis, disposed in said housing body, spaced apart from each other relative to the third axis, and coupled to said first and second retainers, respectively; and
a sprocket mounted in said housing body, disposed between said inner and outer racks, and meshing with said inner and outer racks.

14. The mobile phone hands-free kit as claimed in claim 9, wherein said housing body further has a support block projecting from said front side and adapted to support the bottom side of the mobile phone thereon.

15. The mobile phone hands-free kit as claimed in claim 1, wherein said housing body has a rear side, said mobile phone hands-free kit further comprising a mounting plate coupled pivotally to said rear side of said housing body and adapted to mount said housing body in the passenger room of the automobile.

16. The mobile phone hands-free kit as claimed in claim 15, wherein said rear side of said housing body is formed with sound holes for said speaker unit.

17. The mobile phone hands-free kit as claimed in claim 15, further comprising a cigarette lighter adapter plug connected electrically to said speaker unit.

18. The mobile phone hands-free kit as claimed in claim 17, further comprising a battery charging plug connected electrically to said speaker unit.

19. The mobile phone hands-free kit as claimed in claim 18, wherein said housing body is formed with a recess for removably retaining said battery charging plug therein.

20. The mobile phone hands-free kit as claimed in claim 1, wherein said housing body has a rear side, said mobile phone hands-free kit further comprising a cigarette lighter adapter plug connected electrically to said speaker unit, coupled pivotally to said rear side of said housing body, and adapted to mount said housing body in the passenger room of the automobile.
